(19) United States
(12) Patent Application Publication
(10) Pub. No.: US 2010/0205307 A1
(43) Pub. Date: Aug. 12, 2010

(54) COMMUNICATION CONTROL SYSTEM

(76) Inventor: Hiroyuki Sarugai, Tokyo (JP)

Correspondence Address: BIRCH STEWART KOLASCH & BIRCH, PO BOX 747, FALLS CHURCH, VA, 22040-0747, US

(21) Appl. No.: 12/601,893

(22) PCT Filed: Apr. 3, 2008
(86) PCT No.: PCT/JP2008/000864

§ 371 Date: Nov. 25, 2009

(30) Foreign Application Priority Data
Jul. 31, 2007 (JP) 2007-199509

(51) Int. Cl. G06F 15/16

(52) U.S. Cl. 709/227

(57) ABSTRACT

A communication control system includes external equipment for making a request for required data, a plurality of control units each for transmitting the required data according to the request from the external equipment, and communication control equipment disposed between the external equipment and the control units, for establishing a communication path with the control units according to the request from the external equipment, and for instructing a corresponding one of the control units to transmit the required data.

### FIELD OF THE INVENTION

The present invention relates to a communication control system and a communication control system that establish a logical communication path according to a request from external equipment.

### BACKGROUND OF THE INVENTION

When having a plurality of logical communication paths for establishment of communications with external equipment, a conventional communication control system establishes the logical communication paths according to predetermined order. Another conventional communication control system detects the communication load thereon and changes the order in which it establishes logical communication paths on the basis of this load (for example, refer to patent reference 1).

[Patent reference 1]
JP,2005-10956,A

Conventional communication control equipment is constructed as mentioned above, and a problem with the conventional communication control equipment that establishes logical communication paths with external equipment according to predetermined order is that when changing the order in which the conventional communication control equipment establish the logical communication paths, the software used for the establishment has to be changed. A further problem with the conventional communication control equipment that changes the order in which the conventional communication control equipment establishes the logical communication paths on the basis of the communication load thereon is that because the establishment order of the logical communication paths is determined by an algorithm which is determined beforehand, the software used for the establishment has to be changed as well when the above-mentioned algorithm is changed.

The present invention is made in order to solve the above-mentioned problems, and it is therefore an object of the present invention to provide a communication control system that can dynamically change the order in which the communication control system establishes logical communication paths and that reduces the communication processing load thereon.

### DISCLOSURE OF THE INVENTION

In accordance with the present invention, there is provided a communication control system characterized in including: external equipment for making a request for required data; control units for transmitting the required data which are requested by the above-mentioned external equipment; and communication control equipment for establishing a communication path with the above-mentioned control units according to the request from the above-mentioned external equipment, and for instructing the above-mentioned control units to transmit the required data.

In accordance with the present invention, because the communication control system includes the external equipment for making a request for required data, the control units for transmitting the required data which are requested by the above-mentioned external equipment, and the communication control equipment for establishing a communication path with the above-mentioned control units according to the request from the above-mentioned external equipment, and for instructing the above-mentioned control units to transmit the required data. Therefore, the present invention provides an advantage of being able to dynamically establish an arbitrary logical communication path, and establish only communications with a required function when necessary, thereby reducing the communication processing load and improving the efficiency of the communication processing.

### BRIEF DESCRIPTION OF THE FIGURES

FIG. 1 is a diagram showing an example of the structure of a communication control system in accordance with this Embodiment 1;

FIG. 2 is a diagram showing the internal structure of external equipment in accordance with this Embodiment 1;

FIG. 3 is a diagram showing the internal structure of communication control equipment in accordance with this Embodiment 1;

FIG. 4 is a flow chart showing the operation of the communication control equipment in accordance with this Embodiment 1;

FIG. 5 is a diagram showing a process of establishing a logical communication path between the communication control equipment and the external equipment;

FIG. 6 is a diagram showing a process of establishing a logical communication path with only a navigation control unit;

FIG. 7 is a diagram showing a connection table stored in a storage unit; and

FIG. 8 is a diagram showing the operation of a communication control system in accordance with this Embodiment 2.

### PREFERRED EMBODIMENTS OF THE INVENTION

Hereafter, in order to explain this invention in greater detail, the preferred embodiments of the present invention will be described with reference to the accompanying drawings.

### Embodiment 1

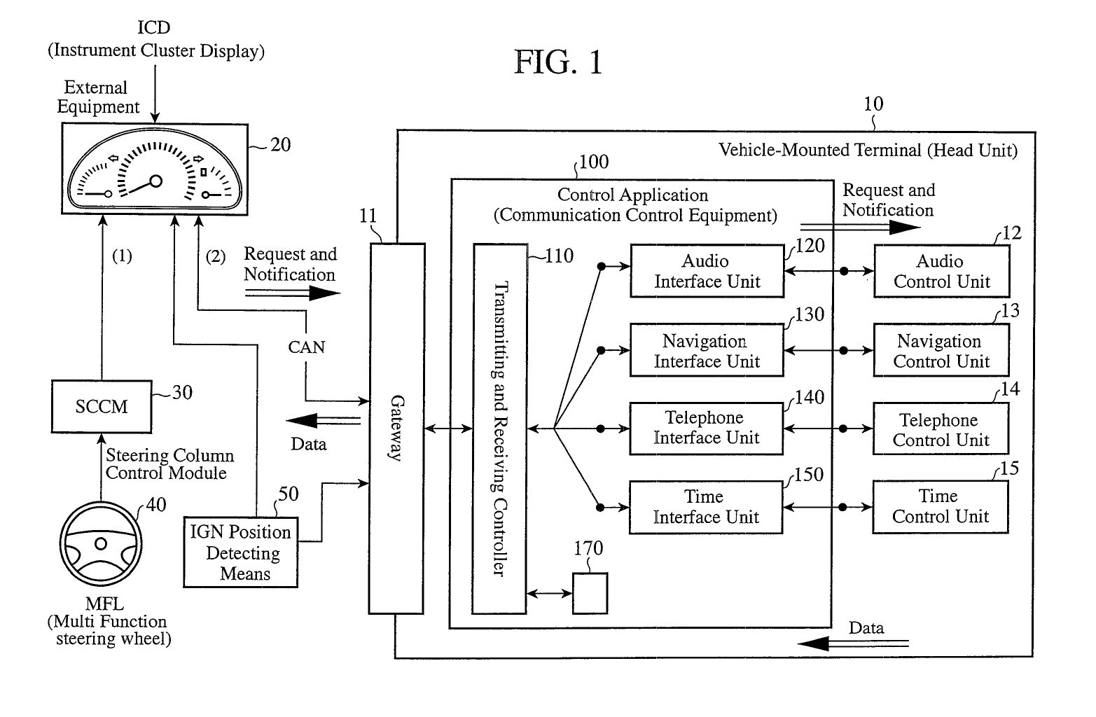

FIG. 1 is a diagram showing an example of the structure of a communication control system in accordance with this Embodiment 1. The communication control system in accordance with this Embodiment 1 is comprised of a vehicle-mounted terminal 10 and external equipment 20. An SCCM (Steering Column Control Module) 30 instructs the external equipment 20 to display required data according to a user's operation on an MFL (Multi Function Steering) 40. The external equipment 20 has a function of displaying data about audio, navigation, telephone, time, etc., and makes a request of the vehicle-mounted terminal 10 for data required for the display according to the instruction from the SCCM 30. An IGN position detecting means 50 notifies an IGN key position to the vehicle-mounted terminal 10 and the external equipment 20.

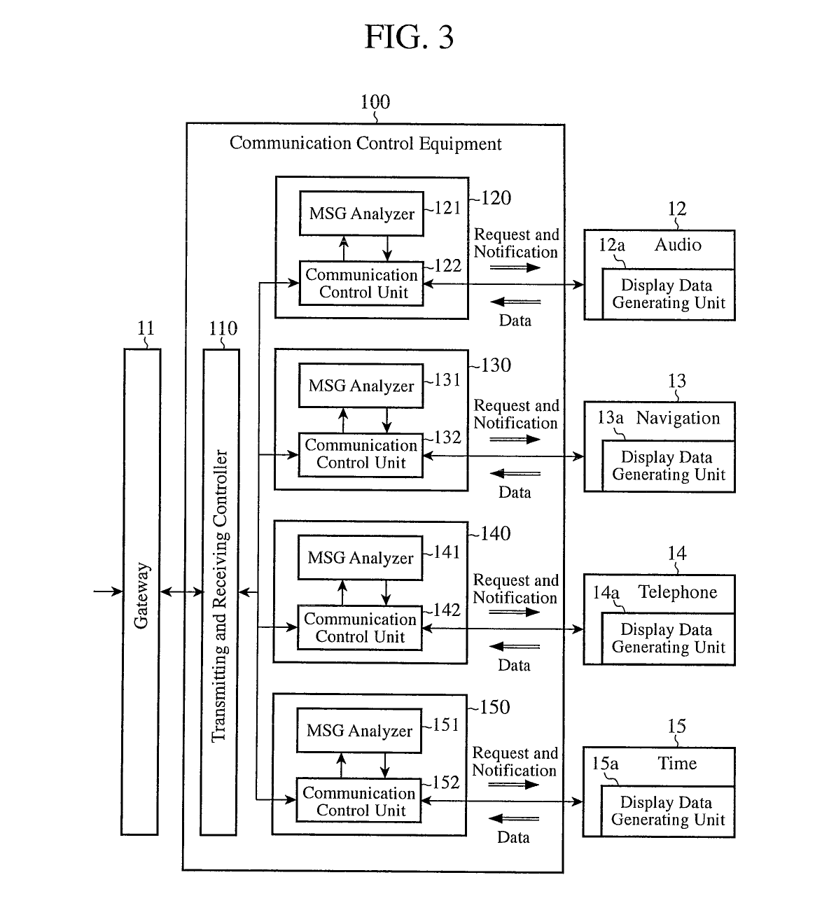

The vehicle-mounted terminal 10 includes a gateway 11 for performing protocol conversion for communications with the external equipment 20, an audio control unit 12 for controlling the audio, a navigation control unit 13 for controlling the navigation, a telephone control unit 14 for controlling the telephone, a time control unit 15 for controlling a clock, and communication control equipment 100 for establishing a communication path with the audio control unit 12, the navigation control unit 13, the telephone control unit 14, or the time control unit 15 according to the request received from the external equipment 20 via the gateway 11 so as to instruct either one of them to transmit the required data to the external equipment 20. In this case, the functions of each of the audio control unit 12, the navigation control unit 13, the telephone control unit 14, and the time control unit 15 are implemented by making a CPU (Central Processing Unit) or the like execute application software corresponding to each of the control units. The internal structure of the communication control unit 100 will be explained in detail with reference to FIG. 3.

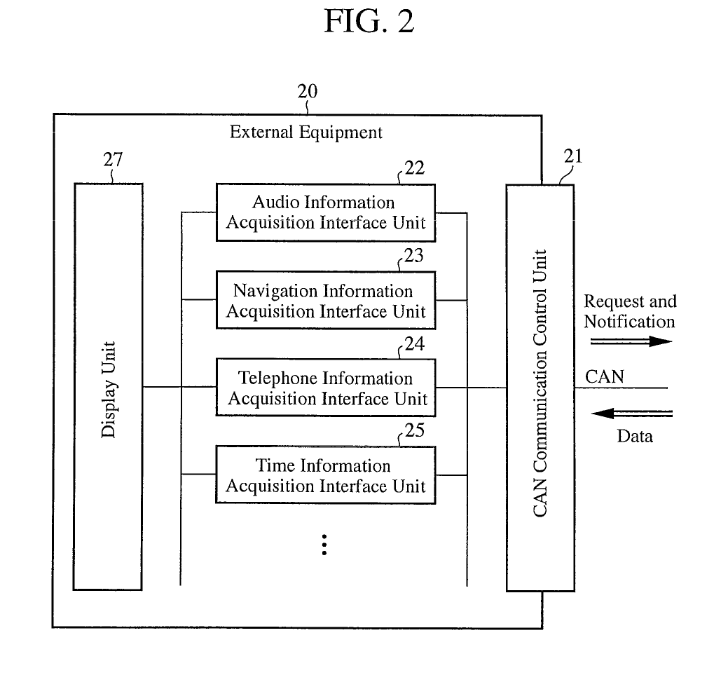

FIG. 2 is a diagram showing the internal structure of the external equipment 20 in accordance with this Embodiment 1. The external equipment 20 includes a CAN (Controller Area Network) communication control unit 21, an audio information acquisition interface unit 22, a navigation information acquisition interface unit 23, a telephone information acquisition interface unit 24, a time information acquisition interface unit 25, and a display unit 27. The CAN communication control unit 21 has a function of communicating with the SCCM 30 and the vehicle-mounted terminal 10, making an analysis to determine for which interface unit each of the instruction transmitted from the SCCM 30 and the data transmitted from the vehicle-mounted terminal 10 is destined, and delivering each of the instruction and the data to the audio information acquisition interface unit 22, the navigation information acquisition interface unit 23, the telephone information acquisition interface unit 24, or the time information acquisition interface unit 25. Furthermore, the functions of each of the audio information acquisition interface unit 22, the navigation information acquisition interface unit 23, the telephone information acquisition interface unit 24, and the time information acquisition interface unit 25 are implemented by making the CPU or the like execute application software corresponding to each of the interface units.

The audio information acquisition interface unit 22, the navigation information acquisition interface unit 23, the telephone information acquisition interface unit 24, and the time information acquisition interface unit 25 make a request to transmit the required data to the audio control unit 12, the navigation control unit 13, the telephone control unit 14, and the time control unit 15 of the vehicle-mounted terminal 10 respectively according to the instruction from the SCCM 30. The display unit 27 displays the data transmitted from the vehicle-mounted terminal 10 thereon for the user.

FIG. 3 is a diagram showing the internal structure of the communication control equipment 100 in accordance with this Embodiment 1. The communication control equipment 100 includes a transmitting and receiving controller 110, an audio interface unit 120, a navigation interface unit 130, a telephone interface unit 140, and a time interface unit 150. In this case, the functions of each of the audio interface unit 120, the navigation interface unit 130, the telephone interface unit 140, and the time interface unit 150 are implemented by making the CPU or the like execute application software corresponding to each of the interface units. The transmitting and receiving controller 110 has a function of communicating with the external equipment 20 via the gateway 11, making an analysis to determine to which interface unit the request transmitted from the external equipment 20 is issued, and delivering the request to the audio interface unit 120, the navigation interface unit 130, the telephone interface unit 140, or the time interface unit 150.

The audio interface unit 120 receives the request transmitted from the transmitting and receiving controller 110 by using a communication control unit 122, makes a request of the audio control unit 12 via the communication control unit 122 to transmit the required data after analyzing the request by using an MSG (Message) analyzer (analyzer) 121, receives the data transmitted from the audio control unit 12 by using the communication control unit 122, analyzes and converts the data by using the MSG analyzer 121, and transmits the converted data to the external equipment 20 via the transmitting and receiving controller 110. Furthermore, the audio control unit 12 generates the data requested by the audio interface unit 120 by using a display data generating unit 12a, and transmits the data to the audio interface unit 120.

The navigation interface unit 130 receives the request outputted from the transmitting and receiving controller 110 by using a communication control unit 132 and makes a request of the navigation control unit 13 via the communication control unit 132 to transmit the required data after analyzing the request by using an MSG analyzer (analyzer) 131. Furthermore, the navigation interface unit receives the data transmitted from the navigation control unit 13 by using the communication control unit 132, analyzes and converts the data by using the MSG analyzer 131, and transmits the converted data to the external equipment 20 via the transmitting and receiving controller 110. Furthermore, the navigation control unit 13 generates the data requested by the navigation interface unit 130 by using a display data generating unit 13a, and transmits the data to the navigation interface unit 130.

The telephone interface unit 140 receives the request outputted from the transmitting and receiving controller 110 by using a communication control unit 142, and makes a request of the telephone control unit 14 via the communication control unit 142 to transmit the required data after analyzing the request by using an MSG analyzer (analyzer) 141. Furthermore, the telephone interface unit receives the data transmitted from the telephone control unit 14 by using the communication control unit 142, analyzes and converts the data by using the MSG analyzer 141, and transmits the converted data to the external equipment 20 via the transmitting and receiving controller 110. Furthermore, the telephone control unit 14 generates the data requested by the telephone interface unit 140 by using a display data generating unit 14a, and transmits the data to the telephone interface unit 140.

The time interface unit 150 receives the request outputted from the transmitting and receiving controller 110 by using a communication control unit 152, and makes a request of the time control unit 15 via the communication control unit 152 to transmit the required data after analyzing the request by using an MSG analyzer (analyzer) 151. Furthermore, the time interface unit receives the data transmitted from the time control unit 15 by using the communication control unit 152, analyzes and converts the data by using the MSG analyzer 151, and transmits the converted data to the external equipment 20 via the transmitting and receiving controller 110. Furthermore, the time control unit 15 generates the data requested by the time interface unit 150 by using a display data generating unit 15a, and transmits the data to the time interface unit 150.

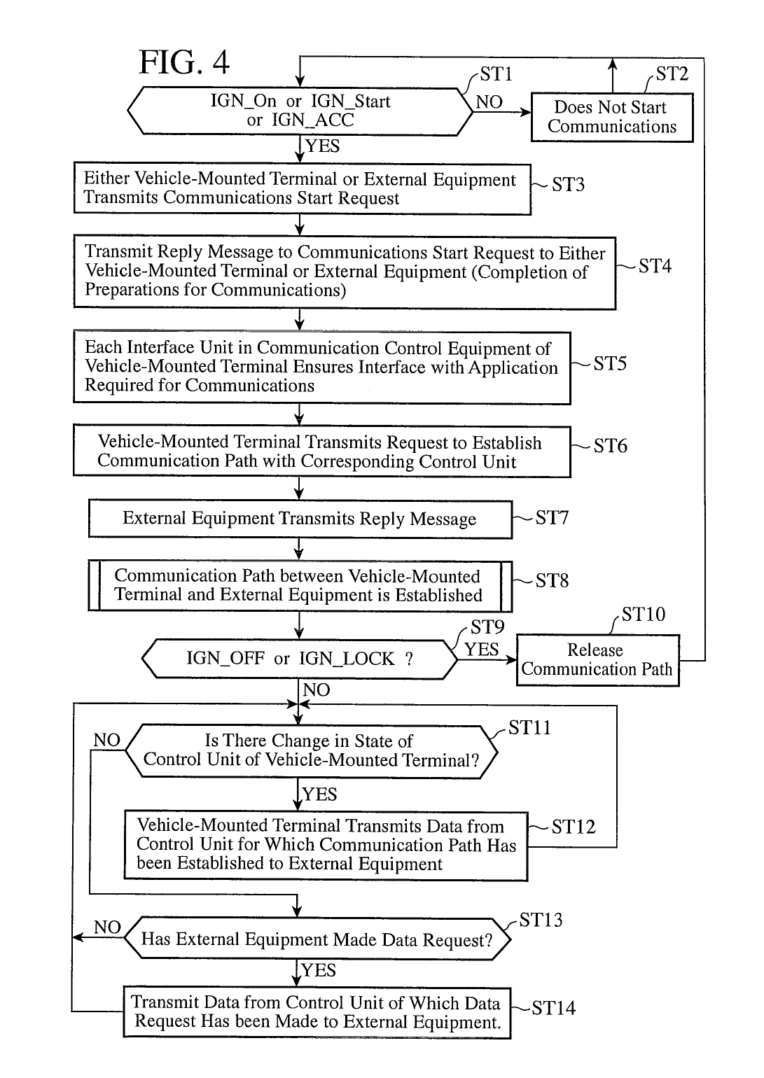

FIG. 4 is a flow chart showing the operation of the communication control equipment in accordance with this Embodiment 1.

The IGN position detecting means 50 determines whether or not the IGN is in the key position of “ON (ON)”, “Start (start)”, or “ACC (accessory)” (step ST1), and, when the IGN is in the key position of “ON”, “Start”, or “ACC”, transmits a signal showing the key position to the vehicle-mounted terminal 10 and the external equipment 20 (step ST1). Furthermore, the signal from the IGN position detecting means 50 is checked within the communication control equipment 100, and, when the IGN is in another key position, any operation of establishing logical communication paths is not started (step ST2).

When receiving the signal transmitted thereto from the IGN position detecting means 50, the CAN communication control unit 21 of the external equipment 20 transmits a request to start communications to the communication control equipment 100 (step ST3). When receiving the communications start request from the external equipment 20 via the gateway 11, the transmitting and receiving controller 110 of the communication control equipment 100 then transmits a notification of a reply to the request to the external equipment 20 to complete preparations for the communications (step ST4).

The transmitting and receiving controller 110 then analyzes the description of the communications start request transmitted from the external equipment 20, and instructs the interface unit which is the destination of the request, among the audio interface unit 120, the navigation interface unit 130, the telephone interface unit 140, and the time interface unit 150, to establish an interface (a communication path) with the corresponding one of the audio control unit 12, the navigation control unit 13, the telephone control unit 14, and the time control unit 15 (step ST6). Next, the interface unit which is the destination of the request, among the audio interface unit 120, the navigation interface unit 130, the telephone interface unit 140, and the time interface unit 15, establishes an interface with the corresponding one of the audio control unit 12, the navigation control unit 13, the telephone control unit 14, and the time control unit 15 according to the request transmitted from the transmitting and receiving controller 110.

Next, the transmitting and receiving controller 110 transmits a request to establish a communication path to the external equipment 20 (step ST7). When then receiving the communication path establishment request, the CAN communication control unit 21 of the external equipment 20 transmits a replay message to the communication control equipment 100, so that a logical communication path between the vehicle-mounted terminal 10 and the external equipment 20 is established (step ST8). In this case, when the IGN is in the key position of “OFF (OFF)” or “LOCK (lock)” (step ST9), the vehicle-mounted terminal 10 and the external equipment 20 release the established logical communication path and end the operation (step ST10). In the above explanation, the example in which the external equipment 20 starts making a request to start communications is shown, though the vehicle-mounted terminal can be constructed in such a way as to start making a request to start communications.

When, in step ST9, the IGN is not in the key position of “OFF” or “LOCK”, the operation of establishing the logical communication path is continued. When the state of the one of the audio control unit 12, the navigation control unit 13, the telephone control unit 14, and the time control unit 15 varies (step ST11), data showing the change are transmitted to the external equipment 20 via the communication control equipment 100 (step ST12) and the data are reflected in the display unit 27 of the external equipment 20. Furthermore, when the external equipment 20 transmits an information request signal (step ST13), the communication control equipment 100 acquires the requested data from the corresponding one of the control units 12 to 15, and then transmits the requested data to the external equipment 20 (step ST14).

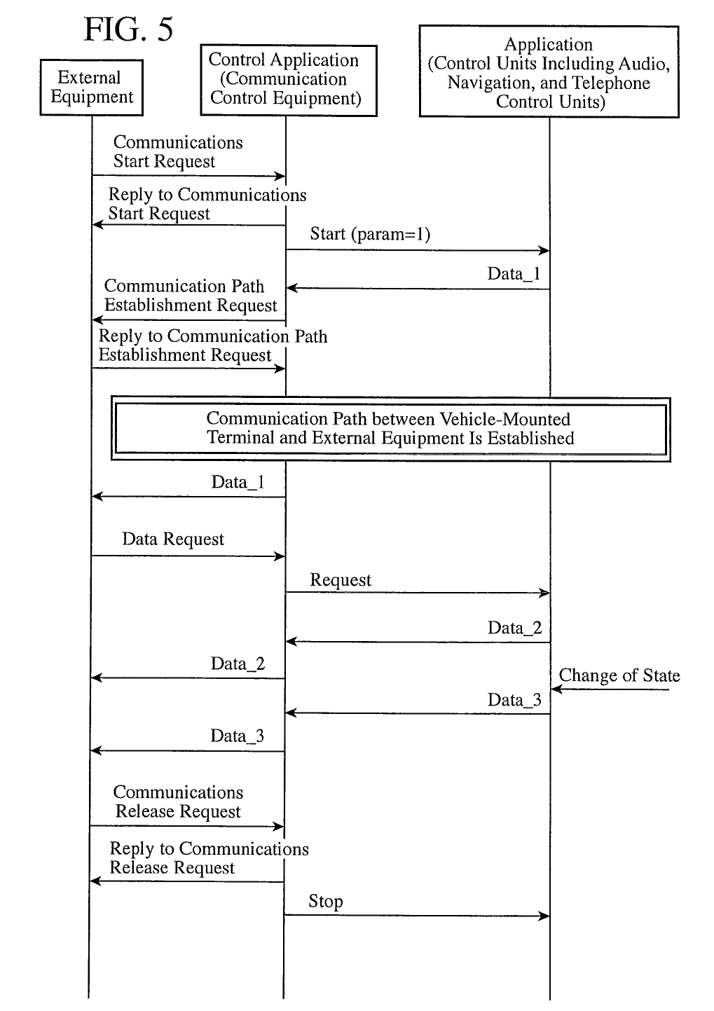

FIG. 5 is a diagram showing the process of establishing a logical communication path between the vehicle-mounted terminal 10 and the external equipment 20. Data showing with which control unit, among the audio control 12, the navigation control unit 13, the telephone control unit 14, and the time control unit 15, the external equipment 20 desires to communicate are added to the communications start request transmitted from the external equipment 20. For example, when carrying out communications with the audio control unit 12, the external equipment adds, as a parameter, “12” to the communications start request, and, when carrying out communications with the navigation control unit 13, the external equipment adds “13” to the communications start request. When then receiving the communication start request, the communication control equipment 100 transmits a communications start reply signal to the external equipment 20.

The transmitting and receiving controller 110 then analyzes the parameter added to the communications start request transmitted from the external equipment 20, and transmits a start signal to one of the interface units 120 to 150 which corresponds to the one of the control units 12 to 15 of which the communication start request has been made so as to instruct the corresponding one of the interface units 120 to 150 to establish an interface. At this time, the transmitting and receiving controller transmits the start signal to the corresponding one of the interface units by adding a parameter of “0” or “1” to the start signal. When the parameter is “1”, the logical communication path with the external equipment 20 is maintained until a stop signal is delivered to the interface unit, transmission and reception of data is carried out between the external equipment 20 and the control unit. In contrast, when the parameter is “0”, after the interface establishment is checked, the stop signal is delivered from the corresponding one of the interface units 120 to 150 to the control unit, and the communication control equipment releases the establishment of the logical communication path with the external equipment 20.

When data are then transmitted from each of the control units 12 to 15, the communication control equipment 100 transmits a communications establishment request signal to the external equipment 20, and, when a reply to the communication establishment request is sent back thereto from the external equipment 20, establishes a logical communication path between the external equipment 20 and the vehicle-mounted terminal 10, and exchange of data between each of the control units 12 to and the external equipment 20 is started via the communication control equipment 100. Concretely, when receiving a request for data transmission from the external equipment 20, the communication control equipment 100 acquires the requested data from each of the control units 12 to 15 and then transmits the requested data to the external equipment 20. Furthermore, when data are transmitted from the control units 12 to 15 according to a state change, the communication control equipment transmits the data to the external equipment 20. In addition, when a communications release request is transmitted from the external equipment 20, the communication control equipment 100 transmits a reply to the communications release request to the external equipment 20, delivers a stop signal to the control units 12 to 15 to release the logical communication path, and ends the processing.

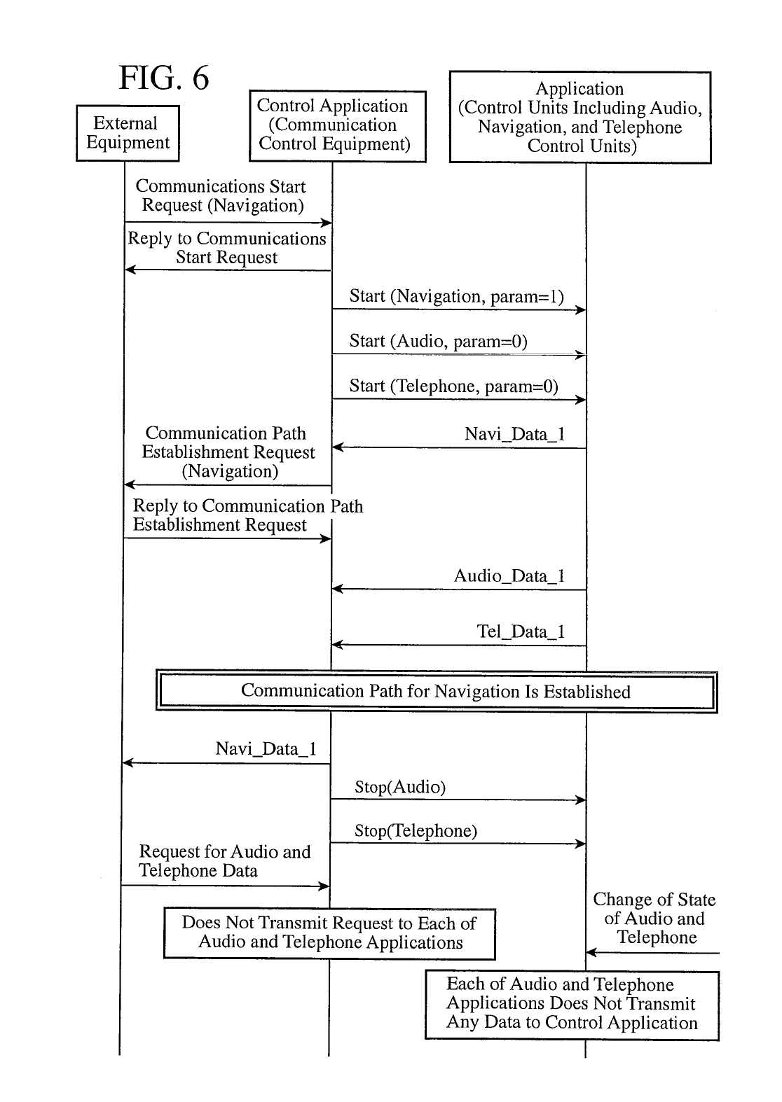

FIG. 6 is a diagram showing the process of establishing a logical communication path when the external equipment 20 makes a request of the communication control equipment to establish only a logical communication path with the navigation control unit 13. In this example, for the sake of simplicity, only establishment of a logical communication path with the audio control unit 12, the navigation control unit 13, or the telephone control unit 14 will be considered. When receiving a request to start communications with the navigation control unit 13 from the external equipment 20, the communication control equipment 100 transmits a reply to the communications start request to the external equipment 20. Next, the communication control equipment 100 adds the parameter of “1” to a start signal and delivers this start signal to the navigation control unit 12, and also adds the parameter of “0” to a start signal and delivers this start signal to the audio control unit 12 and the telephone control unit 14.

When receiving the start signal, the navigation control unit 13 transmits data for the signal to the communication control equipment 100. When the data are transmitted from the navigation control unit 13, the communication control equipment 100 transmits a request to establish a communication path to the external equipment 20 and the external equipment 20 sends a reply to the communication path establishment request back to the communication control equipment, so that a logical communication path between the vehicle-mounted terminal 10 and the external equipment 20 is established. Furthermore, although data are also transmitted by each of the audio control unit 12 and the telephone control 14 in response to the start signal, the communication control equipment 100 does not transmit any communication path establishment request to the external equipment because the communication control equipment has not been requested to transmit any data other than the data from the navigation control unit 13.

After the logical communication path with the external equipment 20 is established, the communication control unit 100 transmits the data transmitted from the navigation control unit to the external equipment 20. Furthermore, the communication control unit delivers a stop signal to the audio control unit 12 and the telephone control unit 14 to release the established logical communication paths. After that, even when a request to start communications with a control unit other than navigation control unit 13 is transmitted from the external equipment 20, the communication control equipment 100 does not transmit this request to the control unit. Furthermore, even if a state change occurs in either one of the audio control unit 12 and the telephone control unit 14 to which the stop signal is delivered, the control unit does not transmit information about the state change to the communication control equipment 100.

As mentioned above, the communication control system in accordance with this Embodiment 1 includes: the external equipment 20 for displaying a vehicle state and for making a request for data required for this display; the plurality of control units 12 to 15 each for transmitting required data according to a request from the external equipment 20; and the communication control equipment 100 having the transmitting and receiving controller 110 disposed between the external equipment 20 and the control units 12 to 15, for receiving and analyzing a request from the external equipment 20, and the plurality of interface units 120 to 150 each for establishing a communication path with a corresponding one of the control units 12 to 15 according to a result of the analysis by the transmitting and receiving controller 110, and for instructing the corresponding control unit to transmit required data. Therefore, this embodiment offers an advantage of being able to dynamically establish an arbitrary logical communication path according to a request from the external equipment 20. This embodiment offers another advantage of being able to lower the internal communication load on the vehicle-mounted terminal 10, and carry out communications with the external equipment 20 efficiently. This embodiment offers a further advantage of being able to enhance the maintainability of the system because it is not necessary to make a replacement of software even when changing the order in which logical communication paths are established between the external equipment 20 and the vehicle-mounted terminal 10.

### Embodiment 2

In Embodiment 2, as shown by a dotted line of FIG. 1, an embodiment in which a storage unit 170 for storing a connection table showing the state of establishment of a logical communication path is disposed in the communication control equipment 100 will be explained.

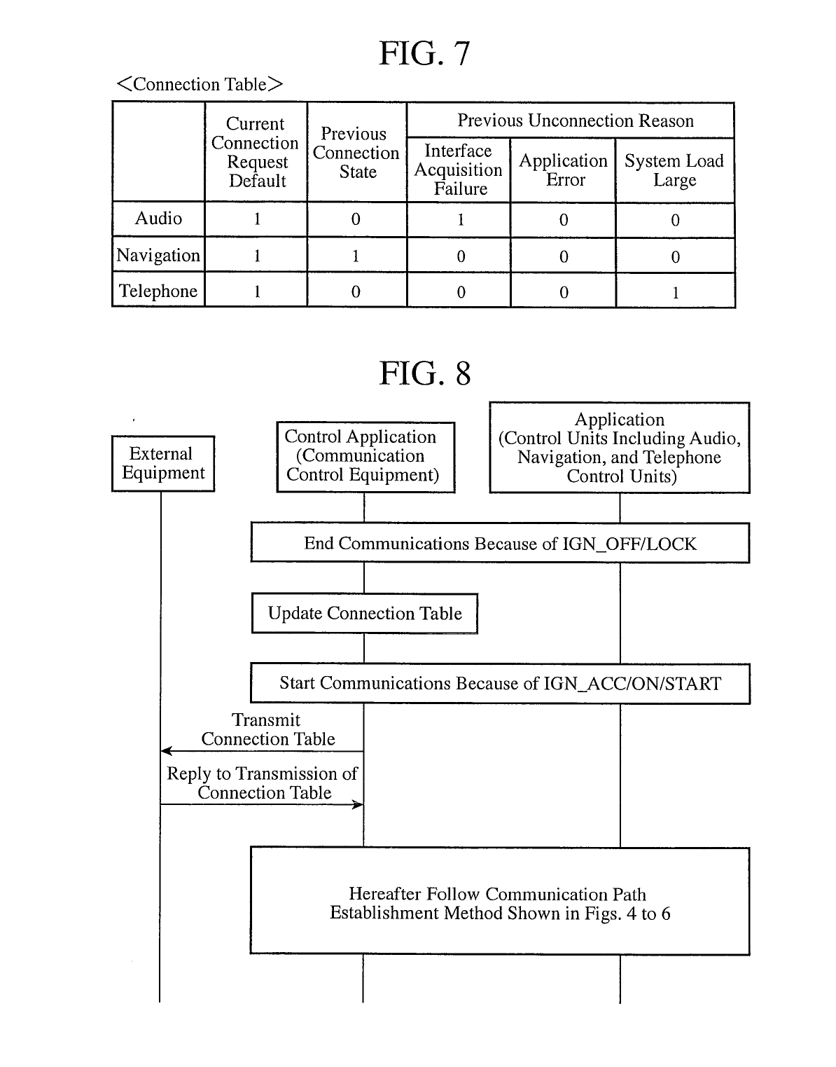

FIG. 7 is a diagram showing the connection table stored in the storage unit 170. In the connection table, a current connection request having a factory default value, a previous connection state showing a state of establishment of a logical communication path at the time of previous communications, and a previous unconnection reason showing the cause of previous unestablishment of a logical communication path are stored for every function. The field of the current connection request can be changed arbitrarily by the user after factory shipment. Because the other structural components of the communication control system are the same as those of Embodiment 1, the explanation of them will be omitted hereafter.

Next, the operation of the communication control system will be explained.

FIG. 8 is a diagram showing the operation of the communication control system in accordance with this Embodiment 2. When the IGN is set to the key position of “OFF” or “LOCK” position and communications are then completed, the transmitting and receiving controller 110 stores the state of establishment of a logical communication path in the storage unit 170 to update the connection table. Concretely, when any logical communication path cannot be established even though a logical communication path establishment request has been made, 0 is recorded into the previous connection state while 1 is stored in the corresponding field of the previous unconnection reason. In contrast, when a logical communication path has been able to be established, 1 is recorded into the previous connection state.

Next, when the IGN is set to the key position of “ON”, “START”, or “ACC”, the transmitting and receiving controller transmits the data stored in the connection table to the external equipment 20, and the external equipment 20 transmits a reply to the transmission of the connection table to the communication control equipment 100. After that, the external equipment 20 makes a request to start communications according to the description of the transmitted connection table. At this time, the external equipment can make the request to start communications according to either the description of the current connection request or the previous unconnection reason. Because a subsequent operation of the system after making a request to start communications is the same as that explained in Embodiment 1, the explanation of the subsequent operation will be omitted hereafter.

As mentioned above, in accordance with this Embodiment 2, the storage unit 170 for storing the connection table showing the state of establishment of a logical communication path is disposed in the communication control apparatus 100, and the communication control apparatus transmits the connection table stored in the storage unit 170 to the external equipment 20 before performing the operation of establishing a logical communication path and the external equipment 20 transmits a communications start request to the communication control equipment 100 according to the description of the transmitted connection table. Therefore, the present embodiment offers an advantage of enabling the vehicle-mounted terminal 10 to manage the state of establishment of a logical communication path, and also enabling the external equipment 10 to establish a logical communication path flexibly according to the description of the connection table.

In Embodiments 1 and 2, the case in which the number of vehicle-mounted terminals 10 is one is explained. As an alternative, a plurality of vehicle-mounted terminals 10 can be connected to the external equipment 20 via CAN. For example, a vehicle-mounted terminal 10 for acquiring vehicle information, such as the traveled distance, vehicle speed, and engine temperature of the vehicle, is further connected to the external equipment 20, and the system is constructed in such a way as to display the vehicle information on the display unit 27 of the external equipment 10.

### INDUSTRIAL APPLICABILITY

As mentioned above, the communication control system in accordance with the present invention establishes only communications with a required function by dynamically establishing an arbitrary logical communication path. Therefore, the communication control system in accordance with the present invention is suitable for use as a communication control system that carries out communications with a vehicle-mounted terminal and external equipment, or the like.

1-3. (canceled)

4. A communication control system characterized in comprising:
external equipment for displaying a vehicle state and for making a request for data required for said display;
a plurality of control units for transmitting the required data according to the request from said external equipment; and
communication control equipment having a transmitting and receiving controller disposed between said external equipment and said control units, for receiving and analyzing the request from said external equipment, and a plurality of interface units disposed between said external equipment and said control units, for establishing a communication path with said control units according to a result of the analysis by said transmitting and receiving controller, and for instructing a corresponding one of the control units to transmit the required data, and characterized in that
while a communication path is established between said external equipment and a certain one of said control units, even if said external equipment transmits a request to start communications to another one of said control units, said communication control equipment does not transmit said request to start communications to said other one of said control units.

5. The communication control system according to claim 4, characterized in that each of said interface units includes a communication control unit for receiving the request transmitted from said transmitting and receiving controller, and an analyzer for analyzing the request received by said communication control unit to instruct a corresponding one of the control units to transmit the required data.

6. The communication control system according to claim 4, characterized in that said communication control equipment includes a storage unit for storing a state of the establishment of the logical communication path at a time of previous communications for each of said control units, and transmits contents of said storage unit to said external equipment.
